(19) United States
(12) Patent Application Publication
(10) Pub. No.: US 2010/0195125 A1
(43) Pub. Date: Aug. 5, 2010

(54) IMAGE CONVERSION DEVICE, IMAGE CONVERSION METHOD, AND CONVERSION PROGRAM

(75) Inventor: Hiroshi Nagashima, Wakayama (JP)

Correspondence Address: ROTHWELL, FIGG, ERNST & MANBECK, P.C., 1425 K STREET, N.W., SUITE 800, WASHINGTON, DC, 20005, US

(73) Assignee: SHIMA SEIKI MANUFACTURING, LTD., Wakayama-shi, Wakayama (JP)

(21) Appl. No.: 12/676,459

(22) PCT Filed: Sep. 1, 2008
(86) PCT No.: PCT/JP2008/065650

§ 371 Date: Mar. 4, 2010

(30) Foreign Application Priority Data
Sep. 7, 2007 (JP) 2007-232718

(51) Int. Cl. H04N 1/60

(52) U.S. Cl. 358/1.9

(57) ABSTRACT

Conversion data D from an original color space into a new color space is set to D=A·B⁻¹, where A is a profile for a printer in the original color space, and B is a profile for the same printer in the new color space. Even when the color space is changed, the same image can be output from the printer.

### BACKGROUND OF THE INVENTION

1. Field of the Invention

The present invention relates to image conversion performed due to the change in a color space, and particularly to enabling outputting of the same color image from a printer even when the color space is changed.

2. Description of the Related Art

Various color spaces are known for handling color images. RGB is a typical color space. There are wide variations in addition to RGB, and a standard RGB color space is called “sRGB.” There is known a technology in which when changing an original color space to a new color space, image data of the original color space is coordinate-converted into image data of the new color space. There is known a technology in which in order to convert an image of, for example, an sRGB color space to an image of a new color space, the image is converted into XYZ or LAB and then into the image of the new color space. These XYZ and LAB are called “connection colors.”

In such a conventional method, however, because the coordinate conversion is performed without taking into consideration matching the printed results to each other when converting the color space, the printed results vary between the image data of the original color space and the image data of the new color space even when the same printer is used. For example, a color space C of the printer is the narrowest, and a new color space B is wider than an original color space A.

When an image of the original color space A exists within the color space C of the printer, generally the same printed result is obtained even when the original color space A is converted into the new color space B. However, in the case where the image of the original color space A is larger than the color space C of the printer, the image is mapped onto the vicinity of the edge of the color space C of the printer by means of gamut mapping, and then printed. In this case, when the image converted into the new color space B is printed out by using the same printer, the image is again mapped onto the vicinity of the edge of the color space C of the printer by means of gamut mapping. However, there is no guarantee that the image is mapped from the original color space A to the same position where the image is mapped. As a result, the printed results seem to be different.

It should be noted that in the case where the original color space A is wider than the new color space B as well, the printed results seem to be different in the image wider than the color space C of the printer. In addition, when a created image is wider than the original color space A and mapped onto the edge of the original color space A, the printed results seem to be different when the color space is converted. In this specification, the image and the image data often mean the same thing.

When gamut mapping is carried out, the printed image has colors different from those of the original image, but the printed image is a desired image of an operator, the printed image is likely a correct printed result. However, when the image of the original color space A is converted to the new color space B and printed out, the operator obtains colors different from his/her desired colors. In some cases the brightness or saturation is adjusted to match the colors so that the desired printed result of the operator is obtained. In this case, the effects of color matching are usually lost when changing the color spaces, and consequently the desired printed result cannot be obtained. The inventor has focused on changing the color spaces, mainly the colors of the printer, to match the printed results to each other when changing the color spaces. This is necessary in order to succeed the image resources of the original color space to the new color space.

### SUMMARY OF THE INVENTION

An object of the present invention is to unchangeably keep a color image printed by a printer, when changing a color space.

An apparatus for converting an image of an original color space to an image of a new color space, the apparatus comprising:

means for obtaining conversion data D=A·B⁻¹;

means for storing the obtained conversion data D; and

means for converting an image K of the original color space into an image L of the new color space on the basis of L=K·D=K·A·B⁻¹ by using the stored conversion data D,

where A is a profile for a printer in the original color space and B is a profile for the same printer in the new color space.

The present invention is also an image conversion method for converting an image of an original color space to an image of a new color space, the method comprising the steps of:

obtaining conversion data D=A·B⁻¹;

storing the obtained conversion data D; and

converting an image K of the original color space into an image L of the new color space on the basis of L=K·D=K·A·B⁻¹ by using the stored conversion data D,

where A is a profile for a printer in the original color space and B is a profile for the same printer in the new color space.

An image conversion program according to the present invention is a program that is stored in an image conversion apparatus configured by a computer and converts an image of an original color space to an image of a new color space by means of the image conversion apparatus, the image conversion program causing the image conversion apparatus to function as:

means for obtaining conversion data D=A·B⁻¹;

means for storing the obtained conversion data D; and

means for converting an image K of the original color space into an image L of the new color space on the basis of L=K·D=K·A·B⁻¹ by using the stored conversion data D,

where A is a profile for a printer in the original color space and B is a profile for the same printer in the new color space.

In the present invention, image data of the original color space is converted to image data of the new color space on the basis of the conversion data D=A·B⁻¹. When the image of the original color space is K and the image of the new color space L, a value to be input to the printer is K·A in the original color space and L·B=K·A·B⁻¹·B=K·A in the new color space, and the images to be printed out match to each other. Therefore, because the color spaces can be changed to obtain the same image using the same printer, the existing image resources can be succeeded.

The present invention can print out the same image even when the color spaces are changed. Moreover, even when the new color space B is wider than the original color space A, the color spaces can be changed so that the printed results match to each other. In addition, the image data obtained after the change can be treated as image data accumulated in the color space B from the first place. As a result, various image data accumulated before changing the color spaces can be used to obtain the same printed result in the new color space. The image conversion apparatus and the image conversion method according to the present invention can be used for printing image data using a color printer. Particularly, the image conversion apparatus and the image conversion method according to the present invention are suitable in a technical field in which the quality of an image printed out by a printer is important, and suitable for conversion of image data of, for example, an apparel product, yarn, knitted fabric and the like.

### BRIEF DESCRIPTION OF THE DRAWINGS

FIG. 1 is a block diagram showing an image conversion apparatus and a peripheral device thereof according to an embodiment;

FIG. 2 is a diagram showing a relationship of an original color space to the color gamut of a printer and a new color space according to the embodiment;

FIG. 3 is a diagram showing the functions of a conversion table according to the embodiment;

FIG. 4 is a block diagram showing an image conversion apparatus and a peripheral device thereof according to a modification; and

FIG. 5 is a flowchart showing an image conversion method according to the embodiment.

### EXPLANATION OF REFERENCE NUMERALS

2, 42 Image conversion apparatus

4 Image memory

6 Profile memory

8 Printer

10 Inverted profile calculator

12 Conversion table storage unit

20 Original color space

21 New color space

22 Gamut of printer

24 to 26 Area

44 Inverse matrix calculator

46 Conversion matrix storage unit

48 Product-sum operator

### DESCRIPTION OF THE PREFERRED EMBODIMENTS

The best mode for implementing the present invention is now described hereinafter, but the present invention is not limited thereto.

FIGS. 1 to 5 show an image conversion apparatus and image conversion method according to an embodiment, wherein the description of the image conversion apparatus applies directly to the image conversion method and an image conversion program unless otherwise noted, and similarly the description of the image conversion method applies directly to the image conversion apparatus and image conversion program. In FIG. 1, reference numeral 2 represents the image conversion apparatus which is used as, for example, a part of an image processor. Reference numeral 4 represents an image memory serving as a peripheral device, which stores an image of an original color space and an image of a new color space. Hereinafter, the image of the original color space is represented as “K,” and the image of the new color space as “L.” A profile memory 6 stores a profile to be printed out by a printer 8. The profile memory 6 stores the profile of the original color space as “A” and the profile of the new color space as “B.”

The profiles A and B may be stored as conversion equations but may preferably stored as conversion tables or conversion matrices. Here, the profiles A and B are stored as a plurality of conversion tables provided to each area within the color spaces. By forming each of the profiles A and B as the plurality of tables, nonlinear conversion can be performed in accordance with the color gamut of the printer, the nonlinear conversion being compression of the images (reducing the distance in the data to be input to the printer, in relation to the distance between two points in each color space) and contraction of the images (making the distance in the data to be input to the printer, longer than the distance in each color space). Hereinafter, because the profiles A and B are approximated to each other, the profiles A and B are configured by the conversion tables or inverse matrices with respect to small sections obtained by finely dividing the areas within each color space, and an RGB value of print data is output, with RGB values of the images K and L as headings. The plurality of conversion tables of the profiles A and B are connected smoothly at a boundary of the areas.

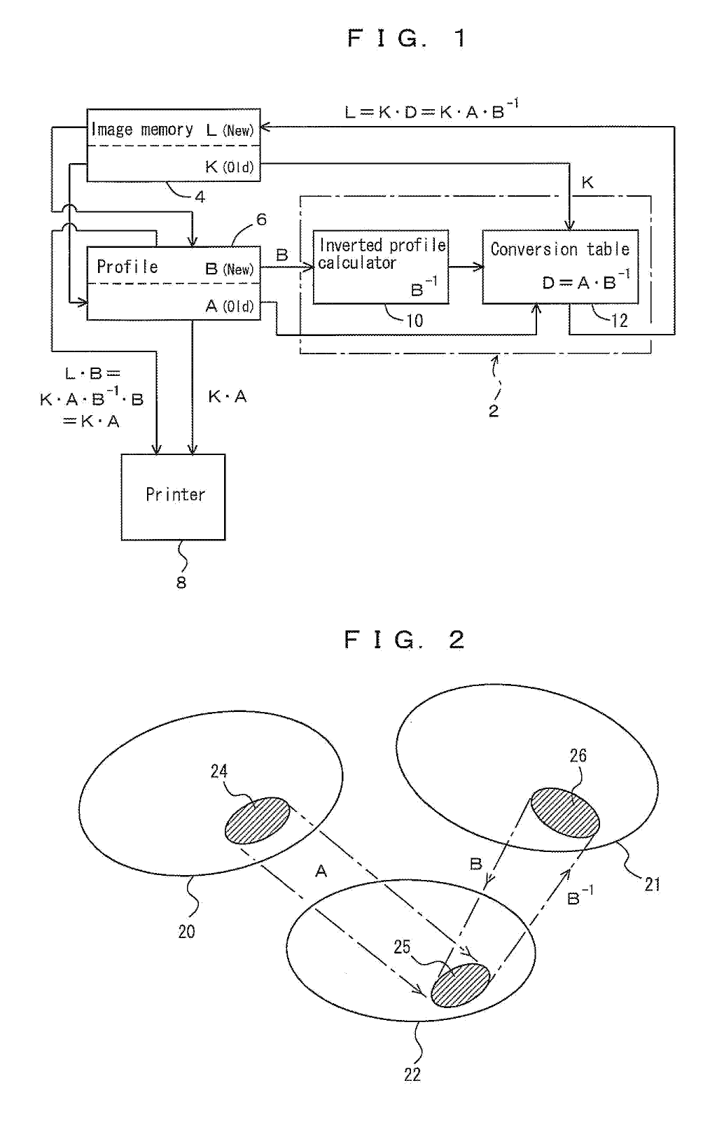

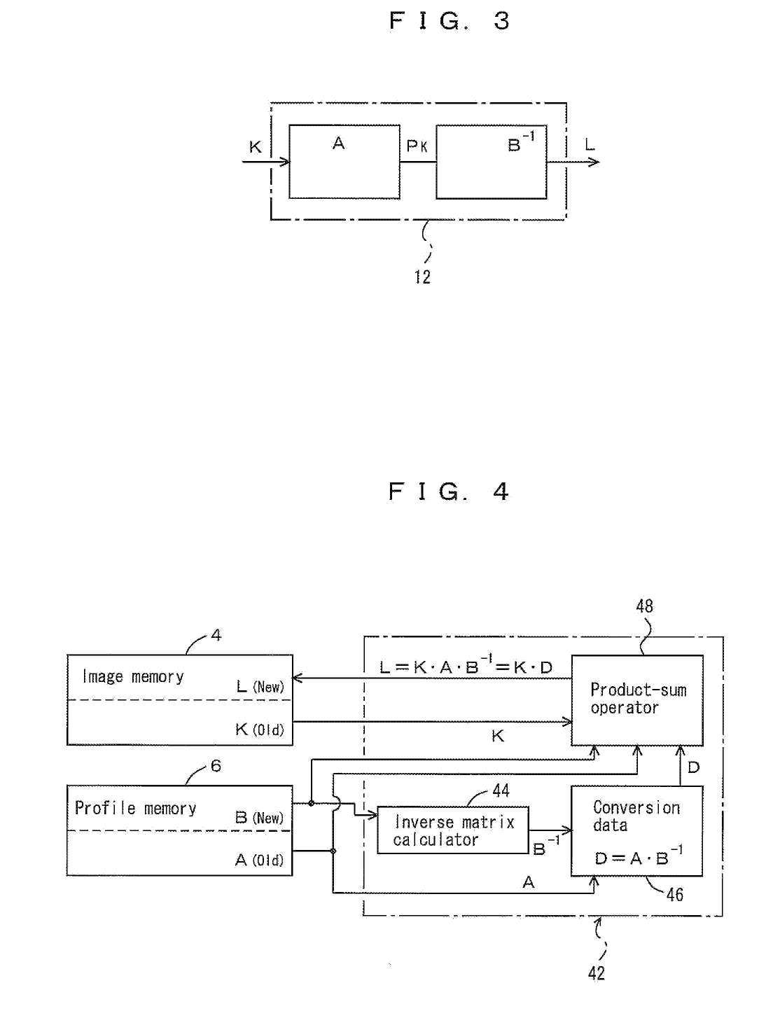

Reference numeral 10 represents an inverted profile calculator that creates the conversion tables showing inverse conversion of the profile B. A conversion table storage unit 12 stores the conversion data D as a plurality of tables. The conversion data D is expressed as D=A·B⁻¹. FIGS. 2 and 3 show the principles of image conversion performed using the tables. Suppose that an area for one conversion table of the profile A within an original color space 20 is represented by reference numeral 24. The area 24 is transferred to an area 25 within a color gamut 22 of the printer by the profile A. Here, an area 26 of a new color space 21 is transferred by the profile B so as to cover an area 25. By obtaining a table corresponding to inverse conversion B⁻¹ of the profile B, conversion data A·B⁻¹ for one table can be obtained. In order to obtain the inverse conversion B⁻¹, it is only necessary to create a table in which the output RGB values of the conversion tables of the profile B are arranged and taken as the headings, and the heading RGB values of the conversion tables of the profile B are output.

Once the inverse conversion B⁻¹ of the profile B is obtained, the table of the inverse conversion B⁻¹ is referenced based on the output RGB values for the heading RGB values of the conversion tables of the profile A, and the output RGB values are taken as output of the conversion data D. This process is repeated for each table of the profile A to obtain the conversion data for the entire original color space 20. FIG. 3 schematically shows how conversion is made from the original image K to the new image L. Print data PK is obtained by the profile A, which is processed by the inverse conversion B⁻¹ to obtain the new image L.

FIG. 4 shows image conversion performed in a profile in which the plurality of conversion matrices are used. An inverse matrix calculator 44 is used to obtain inverse matrix B⁻¹ for the conversion matrices of the profile B, for each conversion matrix of the profile A. The inverse matrix B⁻¹ is multiplied by the conversion matrices of the profile A, and the conversion data is stored in a conversion matrix storage unit 46. Which one of the conversion matrices of the profile B is processed in relation to the individual conversion matrix of the profile A is defined as in FIG. 2. Next, a product-sum operator 48 is used for converting the original image K based on the combined conversion matrix D, whereby the new image L is obtained. Note that the product-sum operator 48 can be used for creating printed images of the profiles A and B.

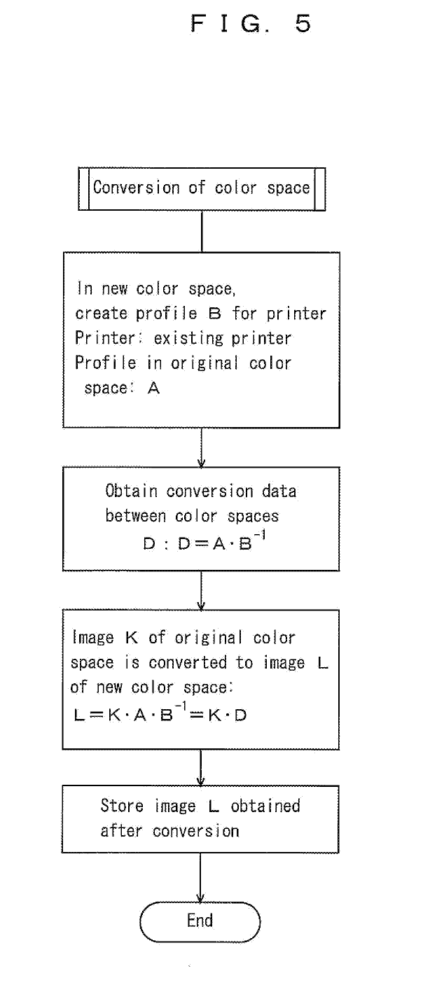

FIG. 5 shows a conversion algorithm of the color spaces according to the embodiment. The profile B for the printer is created for the new color space, and the inverse conversion B⁻¹ thereof is obtained. A profile for the same printer in the original color space is taken as A, and the conversion data D=A·B⁻¹ between the color spaces is obtained. Note that the conversion data D is conversion data for each area within the original color space. The image K of the original color space is obtained as the new color image L on the basis of L=K·D. The output of the printer becomes K·A or L·B=K·A·B⁻¹·B=K·A. The data to be input to the printer 8 does not change even when the color spaces are changed.

The following effects can be obtained by the present embodiment.

(1) The same color image is printed out even when the color spaces are changed. Therefore, image data accumulated prior to the change of the color spaces can be utilized in the new color space.

(2) Even when the new color space is wider than the original color space, the color spaces can be changed so that the same result as the printed result of the original color space can be obtained.

(3) Accurate color space conversion can be performed.

The image conversion program is now described. This program is stored in a storage medium, such as a CDROM, or is stored in the image conversion apparatus 2, 42 configured by a computer, via a carrier wave, and is caused to execute the following instructions. A profile creation instruction is for creating the profile B of the printer in the new color space. An inverted profile calculation instruction is for calculating the inverse conversion B⁻¹ of the profile B as a conversion table or conversion matrix. A combining instruction is for obtaining the conversion data D=A·B⁻¹ in which the inverse conversions B⁻¹ of the profile A and profile B in the original color space are combined, and a storage instruction is for storing the conversion data D in the image conversion apparatus. A conversion instruction is for converting the image K of the original color space into the image L of the new color space on the basis of the L=K·D=K·A·B⁻¹. In this manner, each of the processes shown in FIG. 5 is executed.

1-3. (canceled)

4. An image conversion apparatus for converting an image of an original color space into an image of a new color space,
the image conversion apparatus comprising:
means for obtaining conversion data D=A·B⁻¹;
means for storing the obtained conversion data D; and
means for converting an image K of the original color space into an image L of the new color space on the basis of L=K·D=K·A·B⁻¹ with the stored conversion data D,
where A is a profile for converting the image of the original color space into print data of a printer, and B is a profile for converting the image of the new color space into the print data of the same printer.

5. An image conversion method for converting an image of an original color space into an image of a new color space by the image conversion apparatus,
the image conversion method comprising the steps of:
obtaining conversion data D=A·B⁻¹ by means of the image conversion apparatus;
storing the obtained conversion data D in a memory of the image conversion apparatus; and
converting by the image conversion apparatus an image K of the original color space into an image L of the new color space on the basis of L=K·D=K·A·B⁻¹ with the stored conversion data D,
where A is a profile for converting the image of the original color space into print data of a printer, and B is a profile for converting the image of the new color space into the print data of the same printer.

6. An image conversion program stored in an image conversion apparatus configured by a computer and converts an image of an original color space into an image of a new color space by means of the image conversion apparatus,
the image conversion program causing the image conversion apparatus to function as:
means for obtaining conversion data D=A·B⁻¹;
means for storing the obtained conversion data D; and
means for converting an image K of the original color space into an image L of the new color space on the basis of L=K·D=K·A·B⁻¹ with the stored conversion data D,
where A is a profile for converting the image of the original color space into print data of a printer, and B is a profile for converting the image of the new color space into the print data of the same printer.

7. An image conversion apparatus for converting an image of an original color space to an image of a new color space,
the image conversion apparatus comprising:
means for obtaining conversion data D=A·B⁻¹;
means for storing the obtained conversion data D; and
means for converting an image K of the original color space into an image L of the new color space on the basis of L=K·D=K·A·B⁻¹ with the stored conversion data D,
where A is a profile for nonlinearly converting the image of the original color space into print data of a printer, and B is a profile for nonlinearly converting the image within the new color space into the print data of the same printer.

8. An image conversion method for converting an image of an original color space into an image of a new color space by an image conversion apparatus,
the image conversion method comprising the steps of:
obtaining conversion data D=A·B⁻¹ by means of the image conversion apparatus;
storing the obtained conversion data D in a memory of the image conversion apparatus; and
converting by an image conversion apparatus an image K of the original color space into an image L of the new color space on the basis of L=K·D=K·A·B⁻¹ with the stored conversion data D,
where A is a profile for nonlinearly converting the image of the original color space into print data of a printer, and B is a profile for nonlinearly converting the image within the new color space into the print data of the same printer.

9. An image conversion program stored in an image conversion apparatus configured by a computer and converts an image of an original color space into an image of a new color space by means of the image conversion apparatus,
the image conversion program causing the image conversion apparatus to function as:
means for obtaining conversion data D=A·B⁻¹;
means for storing the obtained conversion data D; and
means for converting an image K of the original color space into an image L of the new color space on the basis of L=K·D=K·A·B⁻¹ with the stored conversion data D,
where A is a profile for nonlinearly converting the image of the original color space into print data of a printer, and B is a profile for nonlinearly converting the image within the new color space into the print data of the same printer.
